(19) United States
(12) Patent Application Publication
(10) Pub. No.: US 2012/0005291 A1
(43) Pub. Date: Jan. 5, 2012

(54) System for Applying a Variety of Policies and Actions to Electronic Messages Before They Leave the Control of the Message Originator

(76) Inventors: Sean Daniel True, Natick, MA (US); Roger L. Matus, Boxborough, MA (US); Charles Ingold, Bedford, MA (US)

(21) Appl. No.: 13/224,108

(22) Filed: Sep. 1, 2011

Related U.S. Application Data
(63) Continuation of application No. 11/816,275, filed on Aug. 14, 2007, now abandoned.

(30) Foreign Application Priority Data
Feb. 14, 2006 (US) PCT/US2006/005256

(51) Int. Cl. G06F 15/16

(52) U.S. Cl. 709/206

(57) ABSTRACT

A system that allows senders to manage electronic messaging content at the point of origin integrates with the client application being used to prepare the message for sending. A send request is intercepted inside the client and a series of message analysis steps is performed that analyze the sender, recipient, message, any attachments to the message, and/or related content and information. The output of the message analysis steps is made available for use with rules that specify the performance of a number of actions. The content analysis steps and the actions taken may be determined by the sender or may be centrally managed and determined by an organization.

### RELATED APPLICATIONS

This application is a continuation of U.S. Patent Application Ser. No. 11/816,275, filed Feb. 14, 2006, which claims the benefit of U.S. Provisional Application Ser. No. 60/652,569, filed Feb. 14, 2005, and claims the benefit under 35 U.S.C. 371 of PCT International Application Ser. No. PCT/US2006/005256, filed Feb. 14, 2006, the entire disclosures of which are herein incorporated by reference.

### FIELD OF THE INVENTION

The invention relates to electronic communications and, in particular, to the classification and management of electronic messages.

### BACKGROUND

The process of sending an electronic message can be broken down into a common set of steps. These steps are broadly true for text messages, but can also be applied to the preparation of purely audio (speech), visual (images/video), or multimedia and mixed content messages. As shown in FIG. 1, these steps are:

A. Prepare 105 a message for transmission inside a client application which is designed to facilitate the preparation of the message.

B. Request 110 to transmit the message to a destination (“Send” the message).

C. Transfer the message to local mail server application 115 that is designed to either deliver or forward the message to a receiving client application, another server application, or into message store or database 120 for delayed reception by such a forwarding server or receiving client. Multiple servers may be involved to relay the message towards its final destination.

D. Receive the message, or notice of message availability, at receiving client 125 designed to display the message to a user, or take a pre-determined action based on the content of the message.

E. Request 130 by an end user, or automatic access by a receiving application which displays 135 the message in a readable, visual, and/or audible form for an end user or which takes an appropriate action based on the programming of the receiving application.

These steps occur in four distinct zones of control, ownership, or responsibility, also shown in FIG. 1:

1. Sending user 150. Before the message leaves the client machine and is committed to the first server, the message is still under the practical control of the user. A message composed and not sent is in this zone.

2. Local server 160. Once a message leaves the client machine, it is typically under the control of a local organization, company, or service provider with whom the sending user has a defined relationship. Messages at this point have not been received by the intended receiver, but are fully discoverable and are not under the control of the sender. If the message is intended for a recipient in the same organization, it may go from this zone of control directly to zone 4 (the receiving user's zone of control).

3. Remote server 170. Once a message leaves the local server, it is typically under the control of a remote organization, company, or service provider with whom the sending user may not have a defined relationship. Messages at this point have not been received by the intended receiver, but are fully discoverable and are not under the control of the sender or his organization. Such messages are open for access by members of the remote organization under rules of which the local sender and local organization have no certain knowledge.

4. Receiving user 180. The receiving user does not typically have control of the message after delivery. It may be fully discoverable and accessible in all prior zones of control.

When e-mail originated, it was used primarily for informal, collaborative communications in a relatively small community. Most messages were desirable, and a premium was placed on the reliable delivery of messages through the system. E-mail is now used to carry a much wider range of messages between people in many organizations. It is used for transmitting confidential information to associates and for normal business and personal communications between individuals, individuals as representatives of organizations, and automated data processing systems. There is an increasing problem with the presence of undesirable messages being transmitted through the system including, but not limited to:

(1) Unsolicited messages sent to a recipient who is unwilling and unhappy to receive them (spam);

(2) Messages from one member of an organization to another member of the same organization which the recipient is unwilling and unhappy to receive (harassment, vicarious liability);

(3) Messages from a member of an organization to another member of the same organization which carry information that is inappropriate for the recipient (Chinese wall, insider information);

(4) Messages between members of separate organizations which carry content which is legally proscribed or controlled, such as under such regulations as Sarbanes-Oxley or HIPAA or SEC blackout periods;

(5) Messages between members of separate organizations which violate the policy or business practices of the sender's organization, such as sending confidential information to a competitor;

(6) Messages which are unclear, cryptic, or could be taken or construed as having a different meaning out of context; and

(7) Messages which are important to the sender, but which may be blocked by content or other mail filters during steps C, D, or E above.

Undesirable messages are often blocked by the recipient client or forwarding servers in steps C, D, and E above, using a variety of techniques such as, but not limited to, blacklisting, header analysis, and content analysis of the message. Messages that are undesirable from the sender's point of view are occasionally blocked during step C, but much less frequently.

Managing messages while they are still under the control of the sender is in many cases the best solution. In particular, it is frequently better to block undesirable messages during step A, while control of the message is still in zone 1. However, while email policies may be created by organizations and users may be trained about what is appropriate to send in an email message, there usually is not an enforcement or advisory mechanism to see that policy is being followed during step A. Once a message has completed step A, it becomes difficult or impossible to recall an injudicious, inappropriate, or unlawful message. Once a message has been sent, it becomes part of a set of electronic records that might be recalled by investigating parties in both civil and legal cases. Further, many company processes that are applied to mail going in and out of the company in steps C or D are not applied to mail inside a company. In addition, many of the policies that need to be implemented by an organization will vary by the organizational role of the user. Rules that are appropriate for a legal department may not be appropriate for the engineering department, for example, and rules that are appropriate for an office worker may not be appropriate for the CEO.

What has been needed, therefore, is a method and system that allows the management of the content of electronic messages before they leave the client email or other electronic messaging application.

### SUMMARY

The present invention is system that allows senders to manage electronic messaging content at the point of origin by analyzing messages before they leave the client application. The system of the invention integrates with the client application being used to prepare the message for sending. In general, it can be invoked when the user hits the “send” button requesting a message transmission, when the user hits a “check compliance” button, or, as the user enters new text in the message, the system can automatically track the content of the message as it changes, analyze it in real-time, and offer advice.

In one aspect of the present invention, a send request is intercepted inside the email client. The system runs a series of message analysis steps, in parallel or in sequence, that analyze the sender, recipient, message, any attachments to the message, and/or related content and information. The output of the message analysis steps is made available for use with rules that can specify the performance of a number of actions including, but not limited to, refusing to send the message, offering the user a chance to edit the message, warning the user, automatically removing specific content, filing the content in a user accessible folder, file, or database, filing the content in a non-user accessible folder, file, or database, forwarding a copy of the message to another person for other action, adding user- or company-determined text to the top or bottom of the message or to the message subject, and allowing the administrator or implementer of the system to add application specific functionality as appropriate, such as playing audible sounds using a multimedia device or setting off inaudible alarms. The content analysis steps and the actions taken may be determined by the sender, or they may be centrally managed and determined by the organization, or a combination of the two.

### BRIEF DESCRIPTION OF THE DRAWINGS

FIG. 1 depicts the generic steps of sending an electronic message and the zones of message control;

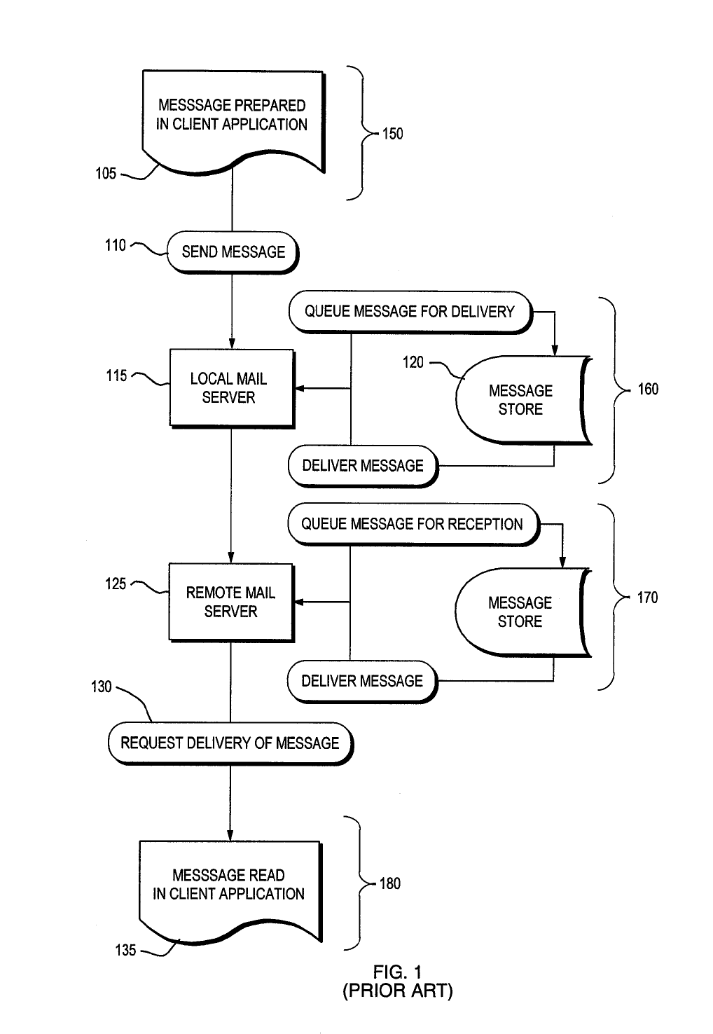

FIG. 2 is a functional flowchart depicting the steps for handling a single message according to an embodiment of the present invention;

FIG. 3 depicts an example email message that contains multiple issues that would typically be addressed by use of the present invention;

FIG. 4 depicts an example dialog presented by an embodiment of the present invention for the purpose of permitting the sender of the message of FIG. 3 to resolve the issues;

FIG. 5 depicts an example warning dialog generated by the rules for the example of FIGS. 3 and 4, offering options determined appropriate to the situation as expressed in the rules file, according to an embodiment of the present invention;

FIG. 6 depicts the sent message of FIG. 3 after treatment according to an embodiment of the present invention; and

FIG. 7 is a block diagram of functional software modules comprising a preferred embodiment of the present invention.

### DETAILED DESCRIPTION

The present invention is a method and system that allows senders to manage electronic messaging content at the point of origin. The present invention analyzes messages and then advises and interacts with the sender in order to prevent undesirable email from completing the step of preparing the message for transmission inside a client application (step A) and entering step B (sending the message).

The system of the invention integrates with the client application being used to prepare the message for sending before it enters step B. In general, it can be invoked in one of three ways:
(a) When the user hits the “send” button requesting a message transmission, the system can intercept the transmission in the context of the client application, analyze it, and then perform the relevant steps, as described later.
(b) When the user hits the “check compliance” button, the current message being created can be analyzed and advice offered before the message is sent. This is analogous to requesting a spell check when a message has been completed.
(c) As the user enters new text in the message, the system can automatically track the content of the message as it changes, analyze it in real-time, and offer advice. This is analogous to a real-time spell check, such as in Microsoft Word. An implementation of this alternative requires ordinary care not to perform resource or computationally expensive pattern matching overly frequently. In the preferred embodiment, the implementation caches results, offers feedback during extended pauses during text entry, and defers interactive dialogs unless explicitly requested. A usage model can be modeled from the ordinary spelling or grammar checkers that are available in systems such as, but not limited to, Microsoft Outlook or the open source aspell project.

In an example embodiment for analyzing a message for action and advice, either during step A or at the time that step B has been requested by the user, the rules and actions can be resident on the sender system, can be centrally located and centrally managed, or can be some combination of the two. For convenience, the system of this embodiment is now described in terms of analysis and advice provided at the time that step B has been requested. Extrapolation of these steps to the alternative scenarios will be clear to one of ordinary skill in the art.

First, the system intercepts a message at the moment that the request to send it has been made. In a preferred embodiment, the request is intercepted in the client email application using standard programming interfaces offered by the client application. In alternate embodiments, the request is intercepted inside the email client using at least one of the many other techniques known in the art such as, but not limited to, code injection, event hooking, and reverse engineering.

Next, the system runs a series of message analysis steps, in parallel or in sequence, that analyze the sender, recipient, message, any attachments to the message (documents, images, video, and audio), and/or related content and information. These analysis steps may be performed on the local machine, or may be requested from a remote server. These analyses may include, but are not limited to:
1. Probabilistic analysis (including Bayesian, support vector, or neural network-based methods) of the message, any attachments, and/or information derived from the attachments of the message. In a preferred embodiment, this analysis may incorporate the method and system disclosed in a copending PCT Patent Application entitled “ Statistical categorization of electronic messages based on an analysis of accompanying images”, which is herein incorporated by reference in its entirety.
2. Scanning the message, attachments, and/or information derived from the attachments for specific key words or phrases.
3. Scanning the message, attachments, and/or information derived from the attachments using regular expressions or other pattern matching methods.
4. Checking an external database of characteristics attributed to the sender of the message.
5. Checking an external database of characteristics attributed to the receiver or receivers of the message.

In the case of probabilistic classifiers, the output of each classifier is separated into three ranges that are configurable using two numbers: a numerical score below which a message is assumed not to be in the category and a numerical score above which in message is assumed to be in the category. The range of scores between these two values is treated as an indicator that the classifier is not sure. This third range can be used to trigger an interactive request for classification by the user, as well as being used for triggering further actions after message classification. The ability to request the user to make an auditable decision about the classification of the message allows a system to continue to train to make more accurate unassisted classifications and also offers the opportunity to catch additional data that can be used in a centralized database or distributed to other designated users in order to improve the automatic classification of messages that they send.

The output of the message analysis steps is made available for use with rules that can specify the performance of a number of actions including, but not limited to:
1. Refusing to send the message
2. Offering the user a chance to edit the message
3. Warning the user, and offering the user a chance to send the message anyway
4. Automatically removing specific content
5. Filing the content in a user accessible folder, file, or database
6. Filing the content in a non-user accessible folder, file, or database
7. Forwarding a copy of the message to another person for other action
8. Adding user-determined text to the top or bottom of the message
9. Adding company-determined text to the top or bottom of the message
10. Adding user-determined text to the message subject
11. Adding company-determined text to the message subject
12. Adding message authentication or encryption using PKI or other suitable message means
13. Allowing the administrator or implementer of the system to add application specific functionality as appropriate, such as playing audible sounds using a multimedia device or setting off inaudible alarms
   The content analysis steps and the actions taken may be determined by the sender, or they may be centrally managed and determined by the organization, or a combination of the two.

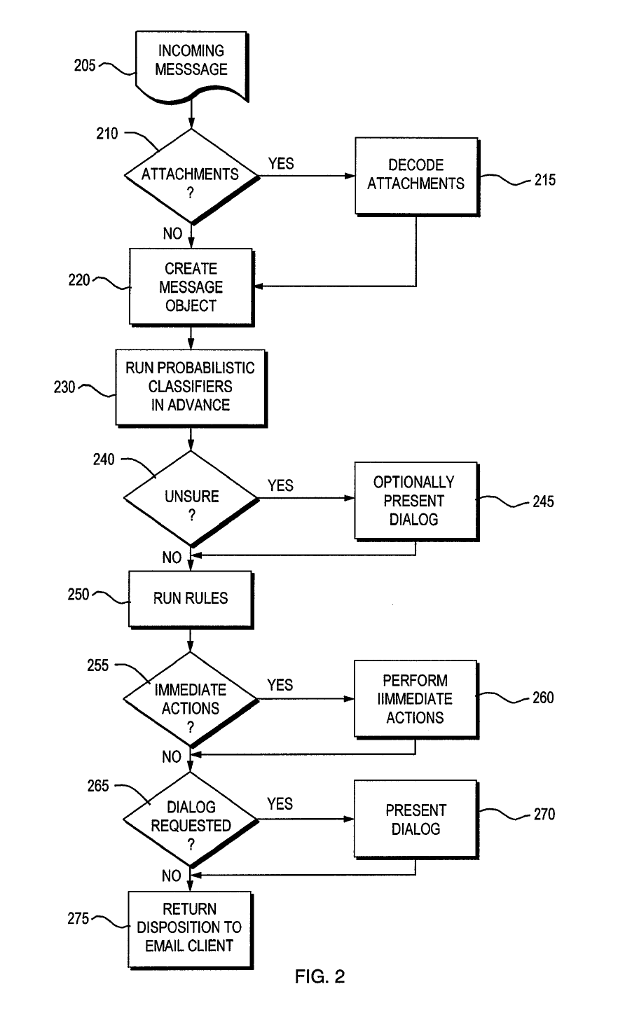

FIG. 2 is a functional flowchart depicting the steps for handling a single message according to a preferred embodiment of the present invention. In FIG. 2, message 205 that a user has requested to send is checked for attachments 210. If present, the attachments are decoded 215. A message object is created 220 and used as input for at least one probabilistic classifier 230. If the result is unsure 240, then an optional user dialog may be presented 245 to obtain more information and/or to allow the user to correct the initial classification. This information, if provided, may optionally be used by the user or by an administrator to correct or train the probabilistic classifier. Next, the previously established rules are applied 250. If immediate actions are required 255 in response to the application of the rules, they are performed 260. If a dialog is requested or required 265, it is presented 270. Finally, the message disposition is returned 275 to the email client.

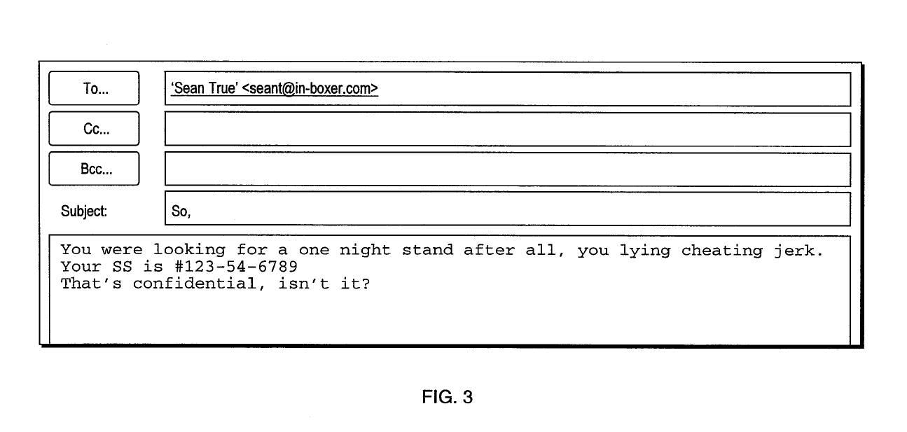

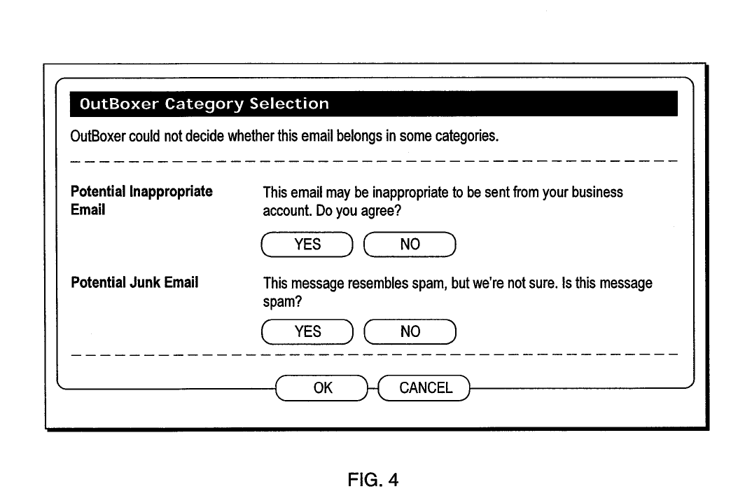

FIG. 3 depicts an example email message that contains multiple issues that would typically be addressed by use of the present invention. When the send button is pressed, two of the probabilistic classifiers return an unsure rating. In this example, the sender is then offered the dialog depicted in FIG. 4, in order to permit resolution of the issues. In this case, the sender selects “Yes” for inappropriate and “No” for Junk email.

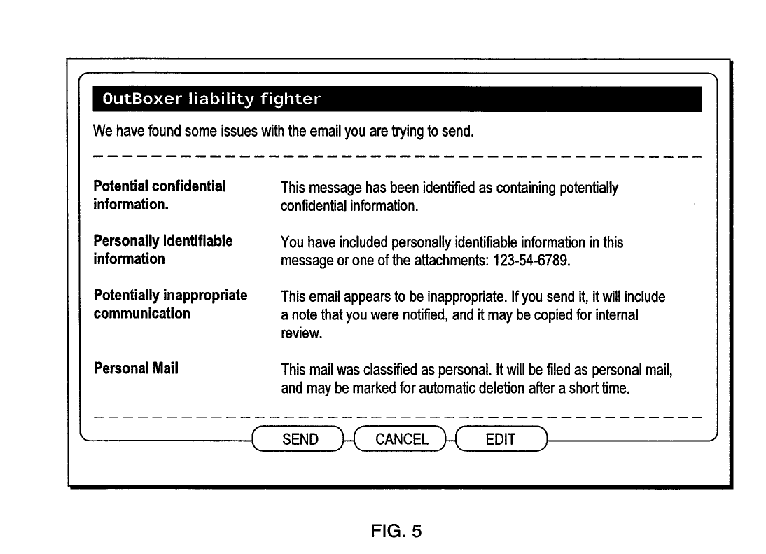

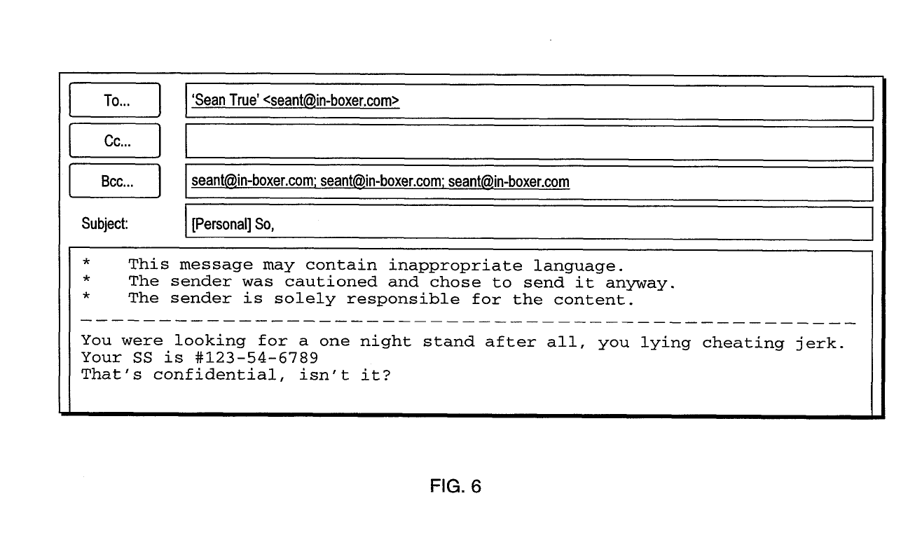

In this example, the rules then generate the warning dialog shown in FIG. 5, which offers options determined appropriate to the situation as expressed in the rules file. When the user selects “send”, the message is treated as described in the rules, including optionally altering the content of the message to notify the recipient of the results of the analysis, as shown in FIG. 6.

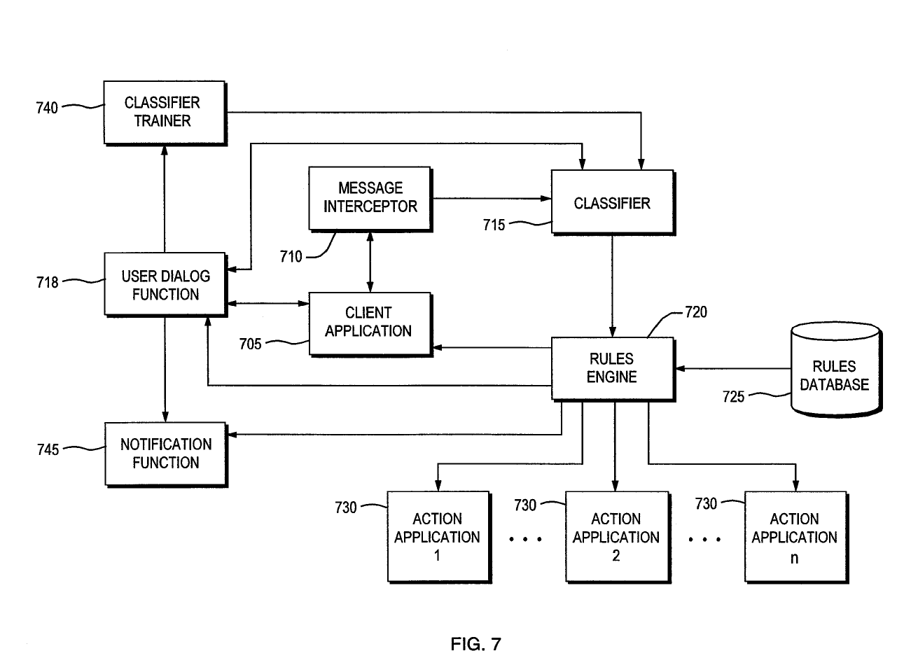

FIG. 7 is a block diagram of functional software modules comprising a preferred embodiment of the present invention. In FIG. 7, client electronic messaging application 705 is mined by message interceptor 710 for messages in progress and/or on the point of leaving client application 705. Message interceptor 710 provides the message to classifier 715. If classifier 715 needs more information to classify a message, or if the system is configured to allow the user to agree to or change the message classification, user dialog function 718 is utilized to query the user. Once the message has been classified by classifier 715, rules engine 720 is utilized to apply rules from rules database 725 to determine what actions, if any should be taken by action applications 730, user dialog function 718, and/or client application 705. If desired, user dialog function 718 may also provide direction to classifier trainer 740, for training of classifier 715, and user dialog function 718 and/or rules engine 720 may provide direction to notification function 745, for notifying an administrator about classification decisions, system actions, and/or specific message content.

A currently preferred implementation of the invention is a program written in Python. However, the program can be constructed in any ordinary programming language. Additional programming languages that would be highly suitable include, but are not limited to, Perl, Java, C++, Lisp, Visual Basic, and C#. The currently preferred client email program is Outlook 2003, however, extensions to other versions of Outlook, and to other email clients such as Notes, Eudora, and other clients known or creatable in the art are ordinary extensions of the program shown here. Extension to web-mail clients including, but not limited to, Hotmail and Gmail, is also possible using ordinary browser-based extensions such as Internet Explorer Browser Helper Objects.

The example code in Table 1 defines a probabilistic classifier for analyzing whether a message is personal mail, according to one implementation of an embodiment of the present invention.

TABLE 1

| | |
|---|---|
| _{—} | <classifier obtype=“pattern” obname=“personal”> |

<title>Potential Personal Email>/title>
<body>We can't tell whether this is personal or business
email. Please pick one.</body>
<path>personal_re.db</path>
<positive>Personal>/positive>
<high>90</high>
<negative>Business</negative>
<low>15</low>
<confirm>no</confirm>
<train>yes</train>

</classifier>

The example code in Table 2 defines a regular expression of classifier for detecting confidential personal information in the form of a Social Security number, according to one implementation of an embodiment of the present invention.

TABLE 2

| | |
|---|---|
| _{—} | <regexp obtype=“pattern” obname=“ssnum”> |

<comment>Match social security # in body</comment>
<field>subject,body</field>
<pattern>[0-9][0-9][0-9]-[0-9][0-9]-[0-9][0-9][0-9][0-9]</pattern>

| | |
|---|---|
| | </regexp> |
| _{—} | <regexp obtype=“pattern” obname=“dirty”> |

The example code in Table 3 defines a set of keywords for detecting references to competitive products or companies, according to one implementation of an embodiment of the present invention.

TABLE 3

| | |
|---|---|
| _{—} | <regexp obtype=“pattern” obname=“competitor”> |

<comment>Don't use competitor products without
trademarks</comment>
<field>subject,body</field>
<pattern>omniva|zix|elron|aungate|orchestria|amicus</pattern>

</regexp>

The example code in Table 4 defines a rule which sends a blind carbon copy of the e-mail that is being sent to a compliance officer for review when the e-mail has been identified as having either confidential information detected by the Social Security number pattern above, or when a probabilistic classifier has determined that the message is probably confidential, according to one implementation of an embodiment of the present invention.

TABLE 4

| | |
|---|---|
| _{—} | <rule obtype=“rule” obname=“confidentialrule”> |

<title>Potentially confidential information.</title>
<reason>This message has been identified as containing

potentially confidential information.</reason>

<when>confidential( ) = = “yes” or ssnum( )</when>
<do>bcc2compliance( )</do>

</rule>

The example code in Table 5 defines a rule, according to one implementation of an embodiment of the present invention, which prevents the user from sending an e-mail message if it contains a set of keywords comprising the dirty words made famous by George Carlin.

TABLE 5

| | |
|---|---|
| _{—} | <rule obtype=“rule” obname=“dirtywordrule” immediate=“yes”> |

<comment>No filth allowed in email.</comment>
<title>Actionable language.</title>
<reason>You have words in your email that are in George
Carlin's 7 dirty word list. You must edit

this email before sending it.</reason>

<when>dirty( )</when>
<do>primarydialog.blockbutton(“send”)</do>

</rule>

These processes can be applied to a variety of messages including, but not limited to, email, instant messaging, SMS, IRC, and other forms of communication which involve text message composition followed by message delivery. These techniques can also be applied to image, video, and audio messaging systems so long as the system meets two provisions: (1) there is a message which is recorded or composed before it is transmitted (as opposed to a live transmission) and (2) there is a process which will extract text or descriptive information from the image, video, or audio message. Examples include, but are not limited to, OCR for images and video, and speech recognition for audio.

In the preferred embodiment, the interface to the client program is a class of type MessagePlugin instantiated by a plugin manager inside the client program. An instance of each outbound message is passed to the method outbound. A list of requested actions is passed back to the plugin manager, which uses the native facilities of the client email program to fulfill the requests. The latter part of the listing has test code suitable for testing the class and its dependent code outside the framework of the client program.

For each message handled by the outbound method, a set of rules are loaded by rulesRoot, any attachments to the message are made available to subsequent processing, and the message is processed by a call to runrules. Any requested actions are returned to the client plugin manager.

Table 6 is an embodiment of code for an example definition of the top-level plugin class.

TABLE 6
class MessagePlugin(MessagePluginBase):

“““ OutBoxer analyzes outbound mail
and advises the user about content issues.
OutBoxer takes actions base on content analysis
and user responses.”””
version = “1.0.2”
enabled = True
attributes = [(“outboundcount”, 0),

(“dialogcount”, 0),
(“rulesfile”,“rules.xml”),
]

priority = −200
def open(self,**options):

MessagePluginBase.open(self, **options)
self.options = options
pluginconfig = options[“pluginconfig”]
# Request filtering of outbound messages
pluginconfig[“filteroutbound”] = True
name = self.name( )
self.config = pluginconfig.get(name,{ })
pluginconfig[name] = self.config
appdatadir = pluginconfig.get(“appdatadir”,os.path.abspath(“.”))
head, tail = os.path.split(appdatadir)
self.ofdir = os.path.join(head,“OutBoxer”)
if not os.path.exists(self.ofdir):

#os.makedirs(self.ofdir)
self.ofdir = appdatadir

self.enabled = True
self.firsttime = True
self.setconfig( )
self.olmi = Dispatch(“OLW.OLMailItem”)
mimetypefile = os.path.join(self.ofdir,“mime.types”)
global _mt
_mt = mimetypes.MimeTypes([mimetypefile])
return True

def close(self, **options):

obClassifiers.resetClassifierCache( )
self.olmi = None
utils = Dispatch(“OLW.OLMAPIUtils”)
utils.Cleanup( )
utils = None
MessagePluginBase.close(self, **options)

def name(self,**options):

return modulename

def menuitem(self):

return modulename

def dialog(self, **options):

import pprint
self.log(“OutBoxer”, pprint.pformat(options))
mgr = options.get(“manager”, None)
#d = ComplianceOptionsDialog(self,mgr)
#d.DoModal( )
mgr = None
self.setconfig( )

def outbound(self, msg, **options):

mgr = options[‘manager’]
subject = msg.GetSubject( )
self.log(“outboxer.outbound”, subject)
def mytokenizer(msg):

skip = [‘x-mailer:none’, ‘reply-to:none’, ‘to:addr:sean’,

‘cc:none’, ‘sender:none’, ‘message-id:invalid’,
‘to:no real name:2**1’,‘to:no real name:2**0’,
‘to:addr:none’,‘from:none’]

for token in msg.tokenize( ):

if token not in skip:

yield token

self.outboundcount += 1
root, context = rulesRoot(os.path.join(self.ofdir, self.rulesfile))
context[“_tokenizer_”] = mytokenizer
context[“_ibmsg_”] = msg
attachments =[ ]
if options.has_key(“item”):

self.olmi.Item = options[“item”]
context[“_olmsg_”] = self.olmi
for i in range(self.olmi.Attachments.Count):

attachment = OLAttachment(self.olmi.Attachments(i+1))
attachments.append(attachment)
attachments = attachments + attachment.embedded( )

else:

context[“_olmsg_”] = None

context[“_attachments_”] = attachments
obmsg = obMessage(msg=msg.GetEmailPackageObject( ))
disposition, result, modified, actions = runRules(obmsg, root, context)
if disposition == “cancel”:

actions = [(“cancel”, None)]

elif disposition == “edit”:

actions = [(“edit”, None)]

context[“_ibmsg_”] = None
self.log (“runrules results”,result)
self.log(“modified”,modified)
self.log(“actions”,actions)
self.log(“modified fields”, obmsg.modifiedfields)
mgr = None
return actions

if_{——}name_{——} == “_{——}main_{——}”:

pluginconfig = {modulename:{ }}
class Dummy:

pass

class DummyMessage:

thesubject = “the subject”
def GetSubject(self):

return self.thesubject

def GetEmailPackageObject(self):

import email
msg = “From: seant@webreply.com\nSubject: % s\n\nMy security number is 523-93-2829. Yours is

123-45-6789\n”“” % self.thesubject

import email
msg = email.message_from_string(msg)
return msg

def tokenize(self):

return str(self.GetEmailPackageObject( )).split( )

manager = Dummy( )
manager.dialog_parser = Dummy( )
manager.dialog_parser.dialogs = [ ]
config = Dummy( )
config.unsure_threshold = .15
config.spam_threshold = .90
msg = DummyMessage( )
mp = MessagePlugin(config=config,pluginconfig=pluginconfig,manager=manager)
mp.progdir = mp.appdatadir = “..”
mp.open(config=config,pluginconfig=pluginconfig,manager=manager)
mp.about( )
mp.dialog(config=config,pluginconfig=pluginconfig,manager=manager)
mp.outbound(msg, config=config,pluginconfig=pluginconfig,manager=manager)
for item in pluginconfig.items( ):

print item

The code listing in Table 7 is an example implementation of a module that implements the loading, managing, and execution of the rules. Two exported procedures perform the core functionality used by the calling code: rulesRoot and runrules. Procedure rulesRoot loads definitions of classifiers, patterns, actions, and rules from an external file in XML format. Procedure runrules applies those rules to a specific message, generating interactive dialogs as needed, and returning a requested set of actions to the caller.

TABLE 7
Listing 2: obMain.py
import os, sys
import BeautifulSoup
import email
if_{——}name_{——} == “_{——}main_{——}”:

basepath = “/src/spambayes/spambayes/Outlook2000”
if not os.path.exists(basepath):

basepath = “/home/src/spambayes/spambayes/Outlook2000”

sys.path.insert(0,basepath)
sys.path.insert(0,os.path.join(basepath,“dialogs”))
sys.path.insert(0,“.”)
sys.path.insert(0,“..\\..”)

import obBase, obPatterns, obDialogs
def loadLists(soup):

import obLists
lists = soup.fetch(attrs={“obtype”:“list”})
for l in lists:

if l.name == “actionlist”:

obLists.obActionList(l)

elif l.name == “patternlist”:

obLists.obPatternList(l)

elif l.name == “rulelist”:

obLists.obRuleList(l)

def loadDialogs(soup):

import obDialogs
dialogmap = obBase.loadObMap(obDialogs)
for a in soup.fetch(attrs={“obtype”:“dialog”,}):

aob = dialogmap.get(a.name, obDialogs.obDialog)(a)

#for a in soup.fetch(attrs={“obtype”:“classifier”}):
# aob = dialogmap.get(a.name, obDialogs.obClassifier)(a)

def loadRules(rulesfile):

bs = BeautifulSoup.BeautifulStoneSoup( )
bs.feed(open(rulesfile).read( ))
loadLists(bs)
loadDialogs(bs)
objects = obBase.obObject.byobname.copy( )
root = objects[“root”]
return root

class obMessage:

def_{——}init_{——}(self, s=None, msg=None):

self.modifiedfields = [ ]
if s:

self.msg = email.message_from_string(s)
self.msghash = hash(s)

else:

self.msg = msg
self.msghash = hash(str(msg))

def_{——}getitem_{——}(self, key):

if key == “body”:

return self.msg.get_payload( )

else:

return self.msg[key]

def_{——}delitem_{——}(self, key):

self.modifiedfields.append((“delitem”,key))
if key == “body”:

self.msg.set_payload(“”)

else:

del self.msg[key]

def_{——}setitem_{——}(self, key, value):

self.modifiedfields.append((“setitem”, key))
if key == “body”:

self.msg.set_payload(value)

else:

self.msg[key] = value

def get(self, key, default):

try:

return self[key]

except:

return default

def_{——}str_{——}(self):

return str(self.msg)

class obHelpers:

def_{——}init_{——}(self, context):

self.obactions = [ ]
self.actions = [ ]
self.subdialogs = [ ]
self.context = context
self.modified = False
self.hasdialog = False
self.disposition = “send”
self.patternmatches = [ ]

def log(self, *args):

for a in args:

print a,

print ‘%s’ % self.context[“msg”][“subject”]

def forward(self, address):

self.log(“forward”, address)
self.actions.append((“forward”,address))

def cc(self, address):

self.log(“cc”, address)
self.actions.append((“cc”,address))

def bcc(self, address):

self.log(“bcc”, address)
self.actions.append((“bcc”,address))

def playwave(self, wavefile):

self.log(“playwave”, wavefile)

def systemsound(self, wavefile):

self.log(“systemsound”, wavefile)

def ringtone(self, wavefile):

self.log(“ringtone”, wavefile)

def copy(self, folder):

self.log(“copy”, folder)
self.actions.append((“copy”,folder))

def delete(self):

self.log(“delete”)

def shred(self, value):

self.log(“shred”, value)
self.modified = True

def addheader(self, header, value):

self.log(“addheader”, header, value)
self.context[“msg”][header]=value
self.modified = True

def setfield(self, field, value):

self.log(“setfield”, header, value)
self.actions.append((“setfield”,(header,value)))

def modifysubject(self, format):

self.log(“modifysubject”, format[:32])
msg = self.context[“msg”]
subject = format % msg
msg[“subject”] = subject
self.log(“modifysubject”, msg[“subject”])
self.modified = True
self.actions.append((“subject”, subject))

def signature(self, format):

self.log(“signature”, format[:32])
msg = self.context[“msg”]
body = msg[“body”]
dict = { }
for h,v in msg.msg.items( ):

dict[h] = v

dict[“body”] = body
try:

body = format % dict

except:

self.log(“Error in signature”)

msg[“body”] = body
self.modified = True
self.actions.append((“body”,body))

def subdialog(self, sd):

self.log(“subdialog %s” % sd)
self.subdialogs.append(sd)
self.hasdialog = True

def dispose(self, s):

self.log(“dispose”, s)
self.disposition = s

def rulesRoot(path):

path = os.path.abspath(path)
head, tail = os.path.split(path)
import obHtml
obHtml.setHtmlpath(head)
obPatterns.classifiers = [ ]
root = loadRules(path)
globaldict = obBase.obObject.byobname.copy( )
globaldict[“context”] = globaldict
globaldict[“_rulespath_”] = head
return root, globaldict

trainingdialogxml = “““
<dialog obtype=“dialog” obname=“trainingdialog”>

<title>OutBoxer Category Selection</title>
<body>OutBoxer could not decide whether this email belongs
in some categories.</body>
<button obtype=“button” value=“ok”>

<label>OK</label>

</button>
<button obtype=“button” value=“cancel”>

<label>Cancel</label>

</button>

</dialog>”””
def runRules(msg, root, context):

context[“_helpers_”] = helpers = obHelpers(context)
context[“msg”] = msg
for classifier in obPatterns.classifiers:

classifier(context)

if helpers.subdialogs:

dialog = obDialogs.obDialog(trainingdialogxml)
result = dialog(context)

In the embodiment shown, objects listed in the external rules file are transformed into Python objects in a way that can be referenced naturally by the rules implementor. This transformation is straightforward in scripting languages such as Python, Perl, Lisp, and C# and more difficult, but still a matter of ordinary programming, in languages such as C++, Visual Basic, and C. The external rules file is comprised of three kinds of lists: patterns, actions, and rules. Each one is loaded by the corresponding procedures, as shown in Table 8, which is a listing of an example implementation of the module which loads and embodies lists. Each list is returned as a first class Python object.

TABLE 8
Listing 3: obList.py

```
import sys
from obBase import obObject, loadObMap
class obRuleList(obObject):
  defobname = “root”
  def _init_(self, soup):
    obObject._init_(self, soup)
    import obRules
    rulemap = loadObMap(obRules)
    self.rules = [symbol]
    for a in soup.fetch(attrs={“obtype”:“rule”}):
      aob = rulemap.get(a.name, obRules.obRule)(a)
      self.rules.append(aob)
      if self.obname <> self.defobname:
        obObject.byobname[“%s_%s” % (self.obname,aob.obname)] =
        aob
  def _call_(self,context={ }):
    helpers = context[“_helpers_”]
    if self.debug:
      self.log(“Running rules”)
    for rule in self.rules:
      rule(context)
    print “ACTIONS”
    print helpers.obactions
    for obaction in helpers.obactions:
      try:
        self.log(“deferred action”, obaction)
        exec(obaction, context)
      except:
        self.log(“Exception in deferred rule.do”, sys.exc_info( )[0],
        sys.exc_info( )[1])
class obActionList(obObject):
  defobname = “rootactions”
  def _init_(self, soup):
    obObject._init_(self, soup)
    import obActions
    actionmap = loadObMap(obActions)
    self.actions = [symbol]
    for a in soup.fetch(attrs={“obtype”:“action”}):
      aob = actionmap.get(a.name, obActions.obAction)(a)
      self.actions.append(aob)
      if self.obname <> self.defobname:
        obObject.byobname[“%s.%s” % (self.obname,aob.obname)] =
        aob
  def _call_(self, context={ }):
    if self.debug:
      self.log(“Run actions”)
    for action in self.actions:
      action(context)
class obPatternList(obObject):
  defobname = “rootpatterns”
  def _init_(self, soup):
    obObject._init_(self, soup)
    import obPatterns
    patternmap = loadObMap(obPatterns)
    self.patterns = [symbol]
    for a in soup.fetch(attrs={“obtype”:“pattern”}):
      aob = patternmap.get(a.name, obPatterns.obPattern)(a)
      self.patterns.append(aob)
      if self.obname <> self.defobname:
        obObject.byobname[“%s.%s” % (self.obname,aob.obname)] =
        aob
  def _call_(self,context={ }):
    if self.debug:
      self.log(“Run patterns”)
    for pattern in self.patterns:
      pattern(context)
```

In this embodiment, each element of a list is a first class Python object derived from a definition in an external XML file. Although the current embodiment shows loading from a single file resident on the clients machine, the embodiment generalizes straightforwardly to inclusion of secondary files on the user's machine and to referencing other files from other locations including, but not limited to, remote file systems, databases, web servers, and other forms of referenceable storage. Table 9 shows an example implementation of the mapping between a parsed element of an XML file and a Python object.

TABLE 9
Listing 4: obBase.py

```
import BeautifulSoup
class obObject:
  defobname = “”
  obseq = 0
  attributes = [“name”,“obname”,“obid”]
  elements = [“comment”]
  byobname = { }
  byobid = { }
  debug = True
  def getID(self):
    obObject.obseq += 1
    return str(obObject.obseq)
  def byID(self, id):
    return byobid[id]
  def byName(self, name):
    return byobname[name]
  def log(self, *args):
    print “%s: ” % self.obname,
    for arg in args:
      print str(arg),
    print
  def logtb(self, *args):
    self.log(*args)
    import traceback
    traceback.print_exc( )
  def _init_(self, soup, moreattributes = [symbol]   , moreelements = [symbol]   :
    if type(soup) == type(“”):
      bs = BeautifulSoup.BeautifulStoneSoup( )
      bs.feed(soup)
      soup = bs
    self.obname = “”
    self.obid = “”
    for a in self.attributes+moreattributes:
      try:
        setattr(self, a, soup[a])
      except:
        if hasattr(soup, a):
          setattr(self, a, getattr(soup,a))
        else:
          setattr(self, a, “”)
    for e in self.elements+moreelements:
      s = soup.first(e)
      if s:
        setattr(self, e, s.string)
      else:
        setattr(self, e, “”)
    if not self.obname:
      if self.defobname:
        self.obname = self.defobname
      else:
        self.obname = self.getID( )
    if not self.obid: self.obid = self.getID( )
    obObject.byobname[self.obname] = self
    obObject.byobid[self.obid] = self
def loadObMap(obmodule):
  obmap = { }
  for a in dir(obmodule):
    if a.startswith(“ob”):
      name = a[2:].lower( )
      obmap[name] = getattr(obmodule, a)
  return obmap
```

Individual patterns in the system are used to identify possible messages that require specific actions. It is straightforward to add additional pattern types to the system. The ones shown here are essential to the operation of the system, but may be extended regularly. Probabilistic classifiers include an “unsure” state which can optionally display a dialog that requires the sender to decide in which category the message actually belongs. The preferred embodiment offers all such decisions as part of a single dialog, but alternate embodiments can offer such decisions sequentially or defer them until they are required as part of the decision making process. Care is taken to make sure that the classifier is executed only once per message. Table 10 shows an example implementation of the patterns included in the preferred embodiment.

TABLE 10
Listing 5: obPatterns.py

```
import os, sys
if _name_ == “_main_”:
  basepath = “/src/spambayes/spambayes/Outlook2000”
  if not os.path.exists(basepath):
    basepath = “/home/src/spambayes/spambayes/Outlook2000”
  sys.path.insert(0,basepath)
  sys.path.insert(0,os.path.join(basepath,“dialogs”))
  sys.path.insert(0,“.”)
  sys.path.insert(0,“..\\..”)
try:
  import utils
  import guiDialog as Dialog
except:
  from dialogs import utils
  from dialogs import guiDialog as Dialog
import re
from obBase import obObject
import sets
class obPattern(obObject):
  def _init_(self, soup):
    obObject._init_(self, soup, [symbol]   , [“field”,“pattern”])
  def _repr_(self):
    return ‘%s %s[%s]: %s on %s’ % (self.name, self.obname, self.obid, self.pattern, self.field)
  def match(self, msg):
    return [symbol]
  def _call_(self, context={ }):
    helpers = context[“_helpers_”]
    msg = context.get(“msg”,None)
    if not msg:
      return [symbol]
    fields = self.field.split(“,”)
    result = [symbol]
    tokens = context.get(“_tokens_”, [symbol]   )
    attachments = context.get(“_attachments_”, [symbol]   )
    for field in fields:
      field = field.strip( )
      if field == “words”:
        for token in tokens:
          try:
            result = result + self.match(token)
          except:
            utils.logtb(“obPattern match: words %s” % token)
      elif field == “attachmentname”:
        for attachment in attachments:
          try:
            result = result + self.match(attachment.filename)
          except:
            utils.logtb(“obPattern match: attachment %s” % attachment)
      elif field == “attachmenttext”:
        for attachment in attachments:
          try:
            result = result + self.match(attachment.text)
          except:
            utils.logtb(“obPattern match: attachment %s” % attachment)
      elif field == “attachmenttype”:
        for attachment in attachments:
          self.log(attachment)
          try:
            result = result + self.match(attachment.mtype)
          except:
            utils.logtb(“obPattern match: attachment %s” % attachment)
      elif field == “attachmentcompression”:
        for attachment in attachments:
          try:
            result = result + self.match(attachment.compression)
          except:
            utils.logtb(“obPattern match: attachment %s” % attachment)
      else:
        val = msg.get(field, “”)
        try:
          result = result + self.match(val)
        except:
          utils.logtb(“obPattern match: field %s” % field)
    if result:
      helpers.patternmatches.append(result)
    return result
class obRegexp(obPattern):
  def _init_(self, soup):
    obPattern._init_(self, soup)
    self.regexp = re.compile(self.pattern,re.IGNORECASE)
  def match(self, val):
    if val is None:
      return [symbol]
    return self.regexp.findall(val)
class obSubstring(obPattern):
  def match(self, val):
    if val is None:
      return [symbol]
    if val.find(self.pattern) >= 0:
      return [self.pattern]
    else:
      return [symbol]
class obExactstring(obPattern):
  def match(self, val):
    if val is None:
      return [symbol]
    if val == self.pattern:
      return [self.pattern]
    else:
      return [symbol]
class obAnystring(obPattern):
  def match(self, val):
    if val:
      return [val]
    else:
      return [symbol]
class obAllstring(obPattern):
  def match(self, val):
    return [“*”]
class obNostring(obPattern):
  def match(self, val):
    return [symbol]
class obRecipientlist(obPattern):
  def match(self, val):
    return [symbol]
class obCclist(obPattern):
  def match(self, val):
    return [symbol]
class obActivedialogs(obPattern):
  def _call_(self, context={ }):
    return context[“_helpers_”].subdialogs
class onDodialog(obPattern):
  elements = obPattern.elements + [“using”]
  def _repr_(self):
    return ‘%s %s[%s]: %s using %s’ % (self.name, self.obname, self.obid, self.pattern, self.using)
  def _call_(self, context={ }):
    print self.title
    print self.body
    return [symbol]
class onDoclassifier(obPattern):
  elements = obPattern.elements + [“using”]
  def _repr_(self):
    return ‘%s %s[%s]: %s using %s’ % (self.name, self.obname, self.obid, self.pattern, self.using)
  def _call_(self, context={ }):
    print self.title
    print self.using
    return [symbol]
from spambayes import storage
from obWinDialogs import *
class ClassifierDialog(IDD_CLASSIFIER_DIALOG):
  def _init_(self, title, body, yesbutton, nobutton):
    self.title = title
    self.body = body
    self.yesbutton = yesbutton
    self.nobutton = nobutton
    Dialog.Dialog._init_(self, self.dt)
  def OnInitDialog(self):
    self.SetWindowText(self.title)
    self.SetDIgItemText(IDC_CLASSIFIER_BODY_TEXT, self.body)
    self.SetDIgItemText(IDC_BUTTON_YES, self.yesbutton)
    self.SetDIgItemText(IDC_BUTTON_NO, self.nobutton)
    self.HookCommand(self.OnButtonYes, IDC_BUTTON_YES)
    self.HookCommand(self.OnButtonNo, IDC_BUTTON_NO)
    return Dialog.Dialog.OnInitDialog(self)
  def OnButtonNo(self, *args):
    self.EndDialog(IDC_BUTTON_NO)
  def OnButtonYes(self, *args):
    self.EndDialog(IDC_BUTTON_YES)
def faketokenizer(s):
  return sets.Set(s.split( ))
import obClassifiers
from obDialogs import obSubdialog
classifiers = [symbol]
class obClassifier(obObject):
  elements = [“title”,“body”,“path”,“low”,“high”,“confirm”,“train”,“positive”,“negative”]
  subdialogxml = “““<subdialog obtype=“subdialog”>
        <title>%(title)s</title>
        <body>%(body)s</body>
        <button obtype=“button” value=“yes”>
          <label>%(positive)s</label>
        </button>
        <button obtype=“button” value=“no”>
          <label>%(negative)s</label>
        </button>
      </subdialog>”””
  def _init_(self, soup):
    obObject._init_(self, soup)
    if self.low == “”: self.low = “15”
    if self.high == “”: self.high = “90”
    if not self.positive: self.positive = “Yes”
    if not self.negative: self.negative = “No”
    d = {“title”:self.title,“body”:self.body,“positive”:self.positive,“negative”:self.negative}
    xml = obClassifier.subdialogxml % d
    self.subdialog = obSubdialog(xml)
    self.low = float(self.low)
    self.high = float(self.high)
    self.score = None
    self.msghash = None
    self.classifier = None
    self.clues = “”
    self.result = None
    classifiers.append(self)
  def _repr_(self):
    return ‘%s[%s]: %s low %.2f high %.2f’ % (self.obname, self.obid, self.title, self.low, self.high)
  def dialog(self, tokens):
    d = ClassifierDialog(self.title, self.body, self.positive, self.negative)
    ok = d.DoModal( )
    if ok == IDC_BUTTON_YES:
      result = “yes”
      if self.train == “yes”:
        self.classifier.learn(tokens, True)
      self.score, self.clues = self.classifier.spamprob(tokens, True)
      self.classifier.store( )
    elif ok == IDC_BUTTON_NO:
      result = “no”
      if self.train == “yes”:
        self.classifier.learn(tokens, False)
      self.score, self.clues = self.classifier.spamprob(tokens, True)
      self.classifier.store( )
    else:
      result = “unsure”
      self.score, self.clues = self.classifier.spamprob(tokens, True)
    return result
  def _call_(self, context = { }):
    helpers = context[“_helpers_”]
    msg = context.get(“msg”,None)
    if not msg:
      return [symbol]
    rulespath = context.get(“_rulespath_”,“.”)
    if not self.classifier:
      # Delay actually accessing classifier till needed
      dbpath = os.path.join(rulespath, “classifiers”, self.path)
      self.classifier = obClassifiers.getClassifier(dbpath)
    msghash = msg.msghash
    if context.get(“_msghash_”, None) <> msghash:
      # Message not yet seen at all
      context[“_msghash_”] = msghash
      tokens = [symbol]
    tokenizer = context.get(“_tokenizer_”, faketokenizer)
    if tokenizer:
      ibmsg = context.get(“_ibmsg_”, str(msg))
      if ibmsg:
        for token in tokenizer(ibmsg):
          tokens.append(token)
      else:
        self.log(“NO IBMSG”)
    context[“_tokens_”] = tokens
    self.log(“TOKENS”, tokens)
  tokens = context.get(“_tokens_”, [symbol]   )
  if self.msghash <> msghash:
    # This classifier has not seen this message
    self.msghash = msghash
    try:
      self.score, clues = self.classifier.spamprob(tokens, True)
    except:
      utils.logtb(self.obname)
      self.score = .5
    self.score = self.score * 100.0
  if not self.result:
    if self.score <= self.low:
      result = “no”
    elif self.score < self.high:
      result = “unsure”
      if self.subdialog not in helpers.subdialogs:
        self.subdialog(context)
    else:
        result = “yes”
  else:
    result = self.result
self.result = result
helpers.patternmatches.append([result])
return result
```

The rules file represents the set of patterns, actions, and policies that are being implemented on behalf of the client. In a preferred embodiment, this file is an ordinary XML file and can be generated, manipulated, parsed, and managed using any set of XML tools. There is no preferred rules file, as the contents are entirely dependent on the requirements of the sender and the sender's organization. Table 11 is an example rules file, according to one embodiment of the present invention.

```
TABLE 11
<?xml version=“1.0” encoding=“UTF-8”?>
<!DOCTYPE OutBoxer SYSTEM “.\obrules.dtd”>
<OutBoxer>
<actionlist obtype=“list” obname=“”>
    <dispose obtype=“action” obname=“dosend”>
      <comment>Send the message without delay</comment>
      <value>send</value>
    </dispose>
    <dispose obtype=“action” obname=“docancel”>
      <comment>Cancel the message without delay.</comment>
      <value>cancel</value>
    </dispose>
    <dispose obtype=“action” obname=“doedit”>
    <comment>Revise the message.</comment>
      <value>edit</value>
    </dispose>
    <copy obtype=“action” obname=“fileaspersonal”>
      <value>\\inbox\sent-personal</value>
    </copy>
    <copy obtype=“action” obname=“fileasinappropriate”>
      <value>\\inbox\sent-inappropriate</value>
    </copy>
    <copy obtype=“action” obname=“fileasspam”>
      <value>\\inbox\sent-spam</value>
    </copy>
    <copy obtype=“action” obname=“fileasbusiness”>
      <value>\\inbox\sent-business</value>
    </copy>
    <copy obtype=“action” obname=“fileasinappropriate”>
      <value>\\inbox\sent-inappropriate</value>
    </copy>
    <modifysubject obtype=“action” obname=“markaspersonal”>
      <value>[Personal] %(subject)s</value>
    </modifysubject>
    <modifysubject obtype=“action” obname=“markasbusiness”>
      <value>[Business] %(subject)s</value>
    </modifysubject>
    <bcc obtype=“action” obname=“bcc2compliance”>
      <value>seant@in-boxer.com</value>
    </bcc>
    <modifysubject obtype=“action” obname=“markasinappropriate”>
      <value>[Inappropriate content] %(subject)s</value>
    </modifysubject>
    <signature obtype=“action” obname=“signcompetitor”>
      <value>%(body)s
=====================================================
+ This message contains references to competitive
+ companies and products. All trademarks are the
+ exclusive property of their owners and are used
+ only for informational purposes.
</value>
    </signature>
    <signature obtype=“action” obname=“signasinappropriate”>
      <value>
+ This message may contain inappropriate language.
+ The sender was cautioned and chose to send it anyway.
+ The sender is solely responsible for the content.
=======================================================
%(body)s</value>
    </signature>
    <signature obtype=“action” obname=“signasspam”>
      <value>
+ This message was easily confused with junk mail at the
+ time the writer sent it.
+ The sender was cautioned and chose to send it anyway.
+ The sender is solely responsible for the content.
==========================================================
%(body)s</value>
    </signature>
    <dialog obtype=“dialog” obname=“primarydialog”>
      <title>OutBoxer liability fighter</title>
      <body>We have found some issues with the email you are trying to send.</body>
      <button obtype=“button” value=“send”>
        <label>Send</label>
      </button>
      <button obtype=“button” value=“cancel”>
        <label>Cancel</label>
      </button>
      <button obtype=“button” value=“edit”>
        <label>Edit</label>
      </button>
    </dialog>
  </actionlist>
  <patternlist obtype=“list”>
    <comment>A list of patterns for reference in rules</comment>
    <regexp obtype=“pattern” obname=“ssnum”>
      <comment>Match social security # in body</comment>
      <field>subject,body,attachmenttext</field>
      <pattern>[0-9][0-9][0-9]−[0-9][0-9]−[0-9][0-9][0-9][0-9]</pattern>
    </regexp>
    <regexp obtype=“pattern” obname=“dirty”>
      <comment>George Carlin's dirty words</comment>
      <field>words</field>
      <pattern>mother\sfucker|cock\ssucker|shit|piss|fuck|cunt</pattern>
    </regexp>
    <regexp obtype=“pattern” obname=“revenue”>
      <comment>Terms related to revenue</comment>
      <field>subject,body</field>
      <pattern>revenue\srecognition|earnings per share</pattern>
    </regexp>
    <regexp obtype=“pattern” obname=“confidentialdoc”>
      <comment>Documents containing the word.</comment>
      <field>attachmenttext</field>
      <pattern>confidential|proprietary</pattern>
    </regexp>
    <regexp obtype=“pattern” obname=“attachedmultimedia”>
      <comment>Attached multimedia files</comment>
      <field>attachmenttype</field>
      <pattern>video/|audio/</pattern>
    </regexp>
    <regexp obtype=“pattern” obname=“competitor”>
      <comment>Don't use competitor products without trademarks</comment>
      <field>subject,body</field>
      <pattern>omniva|zix|elron|aungate|orchestria|amicus</pattern>
    </regexp>
    <regexp obtype=“pattern” obname=“phonenum”>
      <comment>US phone numbers</comment>
      <field>subject,body</field>
      <pattern>[1-9][0-9][0-9][-\.\]+[1-9][0-9][0-9][-\.\]+[0-9][0-9][0-9][0-9]</pattern>
    </regexp>
    <classifier obtype=“pattern” obname=“personal”>
      <title>Potential Personal Email</title>
      <body>We can't tell whether this is personal or business email. Please pick
one.</body>
      <path>personal_re.db</path>
      <positive>Personal</positive>
      <high>90</high>
      <negative>Business</negative>
      <low>15</low>
      <confirm>no</confirm>
      <train>yes</train>
    </classifier>
    <classifier obtype=“pattern” obname=“inappropriate”>
      <title>Potential Inappropriate Email</title>
      <body>This email may be inappropriate to be sent from your business account.
Do you agree?</body>
      <path>inappropriate_re.db</path>
      <positive>Yes</positive>
      <high>90</high>
      <negative>No</negative>
      <low>15</low>
      <confirm>no</confirm>
      <train>yes</train>
    </classifier>
    <classifier obtype=“pattern” obname=“confidential”>
      <title>Confidential Content</title>
      <body>This email may have content which should be considered confidential or
private under company policy or HIPAA regulations. Do you agree?</body>
      <path>confidential_re.db</path>
      <positive>Yes</positive>
      <high>90</high>
      <negative>No</negative>
      <low>15</low>
      <confirm>no</confirm>
      <train>yes</train>
    </classifier>
    <classifier obtype=“pattern” obname=“business”>
      <title>Business Content</title>
      <body>This email may have content which should be recorded permanently
under Sarbanes/Oxley or Graham/Leach/Bliley regulations. Do you agree?</body>
      <path>business_re.db</path>
      <positive>Yes</positive>
      <high>90</high>
      <negative>No</negative>
      <low>15</low>
      <confirm>no</confirm>
      <train>yes</train>
    </classifier>
    <classifier obtype=“pattern” obname=“spam”>
      <title>Potential Junk Email</title>
      <body>This message resembles spam, but we're not sure. Is this message
spam?</body>
      <path>spam.db</path>
      <positive>Yes</positive>
      <high>90</high>
      <negative>No</negative>
      <low>15</low>
      <confirm>no</confirm>
      <train>yes</train>
    </classifier>
    <activedialogs obtype=“pattern” obname=“showprimary”>
    </activedialogs>
  </patternlist>
  <rulelist obtype=“list” obname=“root”>
    <comment>Basic rule set</comment>
    <rule obtype=“rule” obname=“confidentialrule”>
      <title>Potentially confidential information.</title>
      <reason>This message has been identified as containing potentially confidential
information.</reason>
      <when>confidential( ) == “yes” or ssnum( )</when>
      <do>bcc2compliance( )</do>
    </rule>
    <rule obtype=“rule” obname=“personalinforule”>
      <title>Personally identifiable information.</title>
      <reason>You have included personally indentifiable information in this message
or one of the attachments: %(result)s.</reason>
      <when>ssnum( )</when>
      <do>bcc2compliance( )</do>
    </rule>
    <rule obtype=“rule” obname=“product”>
      <comment>Don't talk about competing products by name</comment>
      <title>Competitor's products</title>
      <reason>You have included competitors or their products by name:
%(result)s. OutBoxer will add a trademark disclaimer if you send this message.</reason>
      <when>competitor( )</when>
      <do>signcompetitor( )</do>
    </rule>
    <rule obtype=“rule” obname=“dirtywordrule” immediate=“yes”>
      <comment>No filth allowed in email.</comment>
      <title>Actionable language.</title>
      <reason>You have words in your email that are in George Carlin's 7 dirty word
list. You must edit this email before sending it.</reason>
      <when>dirty( )</when>
      <do>primarydialog.blockbutton(“send”)</do>
    </rule>
    <rule obtype=“rule” obname=“multimediarule” immediate=“yes”>
      <comment>No mailing music, sound, or video</comment>
      <title>Multimedia attachments.</title>
      <reason>Company policy prohibits the sending of multimedia files through email.
Please contact IT about alternative ways to deliver these files when required for business reasons.</reason>
      <when>attachedmultimedia( )</when>
      <do>primarydialog.blockbutton(“send”)</do>
    </rule>
    <rule obtype=“rule” obname=“confidentialdocrule” immediate=“yes”>
      <comment>Document appears to be labeled confidential or
proprietary.</comment>
      <title>Confidential documents attached.</title>
      <reason>One or more of the documents that you attached to this email are
marked as confidential or proprietary. Please remove the attachment before trying to send again.</reason>
      <when>confidentialdoc( )</when>
      <do>primarydialog.blockbutton(“send”)</do>
    </rule>
    <rule obtype=“rule” obname=“inapropriaterule”>
      <title>Potentially inappropriate communication.</title>
      <reason>This email appears to be inappropriate. If you send it, it will include a
note that you were notified, and it may be copied for internal review.</reason>
      <when>inappropriate( ) == “yes” </when>
      <do>bcc2compliance( ); markasinappropriate( ); signasinappropriate( );
fileasinappropriate( )</do>
    </rule>
    <rule obtype=“rule” obname=“personalrule”>
      <comment>Personal and business mail get tagged and handled
differently</comment>
      <title>Personal mail.</title>
      <reason>This mail was classified as personal. It will be filed as personal mail,
and may be marked for automatic deletion after a short time.</reason>
      <when>personal( )==“yes”</when>
      <do>markaspersonal( ); fileaspersonal( )</do>
    </rule>
    <rule obtype=“rule” obname=“businessrule”>
      <when>personal( )== “no”</when>
      <do>fileasbusiness( )</do>
    </rule>
    <rule obtype=“rule” obname=“spamrule”>
      <comment>Warn about spam</comment>
      <title>Junk Email Warning.</title>
      <reason>This mail is easily confused with junk email. It may be too short to be
clear, or may have other characteristics of spam. If you send this email, we will add a disclaimer stating that
you were notified of the issue.</reason>
      <when>spam( )==“yes”</when>
      <do>signasspam( ); fileasspam( )</do>
    </rule>
    <rule obtype=“rule” obname=“showprimarydialog” immediate=“yes”>
      <when>showprimary( )</when>
      <do>primarydialog( )</do>
    </rule>
    <rule obtype=“rule” obname=“edit” immediate=“yes”>
      <when>primarydialog.value==“edit”</when>
      <do>doedit( )</do>
    </rule>
    <rule obtype=“rule” obname=“send” immediate=“yes”>
      <when>primarydialog.value==“send”</when>
      <do>dosend( )</do>
    </rule>
    <rule obtype=“rule” obname=“cancel” immediate=“yes”>
      <when>primarydialog.value==“cancel”</when>
      <do>docancel( )</do>
    </rule>
  </rulelist>
</OutBoxer>
```

The rules file has a grammar that may be described in an ordinary DTD file, such as the example embodiment shown in Table 12. The grammar is an ordinary XML grammar and could be replaced with any comparable grammar that can be straightforwardly parsed with standard XML parsing tools.

TABLE 12
Listing 7: obRules.dtd

```
<?xml version=“1.0” encoding=“UTF-8”?>
<!ELEMENT OutBoxer (actionlist?, patternlist?, rulelist?)>
<!ATTLIST OutBoxer
  xmlns:xsi CDATA #IMPLIED
  xsi:noNamespaceSchemaLocation CDATA #IMPLIED
>
<!ELEMENT actionlist (copy | modifysubject | bcc | dialog | signature |
subdialog | dispose)+>
<!ATTLIST actionlist
  obtype CDATA #REQUIRED
  obname CDATA #REQUIRED
>
<!ELEMENT dispose (comment?,value)>
<!ATTLIST dispose
  obtype CDATA #REQUIRED
  obname CDATA #REQUIRED
>
<!ELEMENT bcc (comment?,value)>
<!ATTLIST bcc
  obtype CDATA #REQUIRED
  obname CDATA #REQUIRED
>
<!ELEMENT body (#PCDATA)>
<!ELEMENT button (label)>
<!ATTLIST button
  obtype CDATA #REQUIRED
  value CDATA #REQUIRED
>
<!ELEMENT positive (#PCDATA)>
<!ELEMENT negative (#PCDATA)>
<!ELEMENT classifier (comment?, title, body, path, positive?,high,
negative?,low, confirm, train)>
<!ATTLIST classifier
  obtype CDATA #REQUIRED
  obname CDATA #REQUIRED
>
<!ELEMENT comment (#PCDATA)>
<!ELEMENT confirm (#PCDATA)>
<!ELEMENT copy (comment?,value)>
<!ATTLIST copy
  obtype CDATA #REQUIRED
  obname CDATA #REQUIRED
>
<!ELEMENT dialog (title, body, button+)>
<!ATTLIST dialog
  obtype CDATA #REQUIRED
  obname CDATA #REQUIRED
>
<!ELEMENT do (#PCDATA)>
<!ELEMENT doclassifier (comment?, using, pattern)>
<!ATTLIST doclassifier
  obtype CDATA #REQUIRED
  obname CDATA #REQUIRED
>
<!ELEMENT field (#PCDATA)>
<!ELEMENT high (#PCDATA)>
<!ELEMENT label (#PCDATA)>
<!ELEMENT low (#PCDATA)>
<!ELEMENT modifysubject (comment?,value)>
<!ATTLIST modifysubject
  obtype CDATA #REQUIRED
  obname CDATA #REQUIRED
>
<!ELEMENT path (#PCDATA)>
<!ELEMENT pattern (#PCDATA)>
<!ELEMENT patternlist (comment | regexp | substring | doclassifier |
classifier| activedialogs)+>
<!ATTLIST patternlist
  obtype CDATA #REQUIRED
>
<!ELEMENT reason (#PCDATA)>
<!ELEMENT regexp (comment?, field, pattern)>
<!ATTLIST regexp
  obtype CDATA #REQUIRED
  obname CDATA #REQUIRED
>
<!ELEMENT rule (comment?, title?, reason?, when, do)>
<!ATTLIST rule
  obtype CDATA #REQUIRED
  obname CDATA #REQUIRED
  immediate (yes | no) #IMPLIED
  stop (yes | no) #IMPLIED
>
<!ELEMENT rulelist (comment?, rule+)>
<!ATTLIST rulelist
  obtype CDATA #REQUIRED
  obname CDATA #REQUIRED
>
<!ELEMENT signature (comment?,value)>
<!ATTLIST signature
  obtype CDATA #REQUIRED
  obname CDATA #REQUIRED
>
<!ELEMENT subdialog (comment?, title, body, button+)>
<!ATTLIST subdialog
  obtype CDATA #REQUIRED
  obname CDATA #REQUIRED
>
<!ELEMENT substring (comment?, field, pattern)>
<!ATTLIST substring
  obtype CDATA #REQUIRED
  obname CDATA #REQUIRED
>
<!ELEMENT activedialogs (comment?, field?, pattern?)>
<!ATTLIST activedialogs
  obtype CDATA #REQUIRED
  obname CDATA #REQUIRED
>
<!ELEMENT title (#PCDATA)>
<!ELEMENT train (#PCDATA)>
<!ELEMENT using (#PCDATA)>
<!ELEMENT value (#PCDATA)>
<!ELEMENT when (#PCDATA)>
```

While a preferred software embodiment is disclosed, many other implementations will occur to one of ordinary skill in the art and are all within the scope of the invention. The currently preferred implementation of the invention is as a software component plug-in to an email client, but any other implementation known in the art would be suitable including, but not limited to: (a) a complete email client, with integrated functionality; (2) a complete web application, with integrated functionality; (3) a software component plug-in to other document generation programs, such as Microsoft Word; (4) an entire document generating program; and (5) a server service, providing centralized handling, like a central document comparison system.

Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

What is claimed is:

1. A method for managing electronic messages comprising the steps, in combination, of:
applying at least one message classification technique to an outgoing message, before it leaves control of the message originator and enters the domain of the sending organization, the message classification technique being applied to produce at least one classification output, the message classification technique comprising a probabilistic analysis of at least one of the message, attachments to the message, or information derived from attachments to the message; and
performing at least one of a set of designated actions on the message in response to the classification output.

2. The method of claim 1, wherein the at least one message classification technique is implemented by a probabilistic classifier employing a method selected from the group consisting of Bayesian, support vector, and neural network-based methods.

3. The method of claim 1, wherein the set of designated actions is selected from the group consisting of blocking the message, forwarding the message, labeling the message, and inserting the message into a database.

4. The method of claim 1, further comprising the step of intercepting a request to send the outgoing message in the client e-mail application used by the message originator in order to classify and take action on the message.

5. The method of claim 4, wherein the request is intercepted in the client email application using standard programming interfaces offered by the client application.

6. The method of claim 4, wherein the request is intercepted inside the client email application client using at least one technique selected from the group comprised of code injection, event hooking, and reverse engineering.

7. The method of claim 1, further comprising the step of offering the message originator a sender an opportunity to correct a message classification in an interactive dialog before the designated action is performed.

8. The method of claim 2, further comprising the step of offering the message originator a sender an opportunity to correct or train the probabilistic classifier when the classifier produced a score in an unsure range of scores.

9. The method of claim 8, further comprising the step of forwarding information derived from correction of the probabilistic classifier to a central database.

10. The method of claim 8, further comprising the step of forwarding information derived from correction of the probabilistic classifier directly to other designated users for use in further message classification.

11. The method of claim 1, wherein the step of applying at least one message classification technique is performed on a separate machine or server.

12. A tangible computer memory device, the memory device containing code which, when executed in a computer processor, performs the steps of:
applying at least one message classification technique to an outgoing message before it leaves control of the message originator and enters the domain of the sending organization, the message classification technique comprising a probabilistic analysis of at least one of the message, attachments to the message, or information derived from attachments to the message; and
performing at least one of a set of designated actions on the message in response to an output from the step of applying at least one message classification technique.

13. The memory device of claim 12, the memory device further containing code which, when executed in a computer processor, performs the step of intercepting a request to send the outgoing message in the client e-mail application used by the message originator in order to classify and take action on the message.

14. The memory device of claim 12, the memory device further containing code which, when executed in a computer processor, performs the step of offering the message originator a sender an opportunity to correct a message classification in an interactive dialog before the designated action is performed.

15. The memory device of claim 12, wherein the at least one message classification technique is implemented by a probabilistic classifier employing a method selected from the group consisting of Bayesian, support vector, and neural network-based methods.

16. A system for managing electronic messages, comprising:
a non-transitory computer-readable storage medium, the non-transitory computer-readable storage medium containing therein software modules configured as:
outgoing message interceptor, the outgoing message interceptor being configured to intercept an outgoing message before it leaves the control of the message originator and enters the domain of the sending organization comprising instructions, encoded in at least one tangible computer-readable medium, for directing the actions of at least one computer processor;
outgoing message classifier, the outgoing message classifier comprising instructions, encoded in at least one tangible computer-readable medium, for directing the actions of at least one computer processor, the message classifier producing at least one classification result for a message intercepted by the message interceptor, wherein the message classifier employs a message classification technique comprising a probabilistic analysis of at least one of the message, attachments to the message, or information derived from attachments to the message; and
rules application engine for applying policies to the message classification result and directing a possible subsequent action to take with regard to the intercepted message; and, the rules application engine comprising instructions, encoded in at least one tangible computer-readable medium, for directing the actions of at least one computer processor.
a computer processor adapted for executing the software modules.

17. The system of claim 16, the non-transitory computer-readable storage medium further containing a software module configured as comprising a user dialog function for notifying the message originator a sender of an intercepted message of violation of the policies via a user interface device, the user dialog function comprising instructions, encoded in at least one tangible computer-readable medium, for directing the actions of at least one computer processor.

18. The system of claim 17, wherein the user dialog function also solicits an instruction from the message originator sender via a user interface device as to an action to be taken.

19. The system of claim 18, the non-transitory computer-readable storage medium further containing a software module configured as comprising a trainer for the message classifier, the trainer comprising instructions, encoded in at least one tangible computer-readable medium, for directing the actions of at least one computer processor, the trainer being responsive to information derived from the instruction.

20. The system of claim 18, the non-transitory computer-readable storage medium further containing a software module configured as comprising a notification facility for sending information derived from output of the message classifier, output of the rules application engine, or the instruction to an administrator via a user interface device, the notification facility comprising instructions, encoded in at least one tangible computer-readable medium, for directing the actions of at least one computer processor.
